(19) United States
(12) Patent Application Publication
(10) Pub. No.: US 2003/0214530 A1
(43) Pub. Date: Nov. 20, 2003

(54) Multiuser real-scene tour simulation system and method of the same

(76) Inventors: Cher Wang, Taipei (TW); Parkson Kuo, Taipei (TW)

Correspondence Address: Raymond Sun, 12420 Woodhall Way, Tustin, CA, 92782, US

(21) Appl. No.: 10/347,724

(22) Filed: Jan. 21, 2003

(30) Foreign Application Priority Data
May 14, 2002 (TW) 91109958

(51) Int. Cl. G09G 5/00

(52) U.S. Cl. 345/757

(57) ABSTRACT

The present invention relates to a multi-user real-scene tour simulation system and method of the same. Especially, the present invention relates to a multi-user real-scene tour simulation system and method of the same that can provide multiple users or a single user an indoor real-scene simulation tour. A tour location (tour destination) in a tour location display system is first selected by a user and the relevant environment parameters of the tour location will be loaded into the system for simulation. The user can select either a single user mode or a multi-user mode. The user's video and audio information will then be transmitted to all other users traveling in the same group, and the real-scene tour simulation system of the present invention will simulate the real scene of a tour based on the environment parameters associated with the tour location as well as the user's video and audio information, and then, the result of the simulation will be presented to the user.

### BACKGROUND OF THE INVENTION

(a). Field of the Invention

The present invention relates to a real-scene tour simulation system and method of the same. Especially, the present invention relates to a multi-user real-scene tour simulation system and method that can provide multiple users or a single user an interactive indoor real-scene simulation tour.

(b). Description of the Prior Arts

As technology advancing rapidly day by day, people are getting tense in daily life. In order to catch up a working pace, modem people need to spend more time on job and in learning, therefore, in the spare time, they normally do not have too much time and energy for outdoor activities. However, local popular tourist spots are always crowded with people in weekends and during holiday periods, moreover, an international tour trip needs longer time for arrangement. That is why, in holiday, many people rather stay at home reading books or magazines, browsing the Internet or playing computer game than going outdoor. Obviously, people living in the modem age have better material life, while the quality of life is really awful.

Also, because of the sophisticated communication technology, a global village is forming; many businessmen are traveling around the world everyday. However, the purpose of their trip is limited to business; they only can take a brief look at the tourist spots during the breaks of their business trips. However, for the constrains of time, their sightseeing is just only a passing glance at things, and photos might be taken for memorial if there is a chance. Moreover, it is unlikely to visit the same place again, not under a business trip, even the place is worth visiting for many times, which is quite a pity. Furthermore, individual requirements for tours are various; some people like traveling alone while some prefer going with others. Therefore, if the modem technology could build up a world tour spot information system and shown interiorly, people would take a tour for sightseeing depending on their own choices without being limited by the schedule of the holiday and the weariness of tour.

### SUMMARY OF THE INVENTION

The primary aspect of the present invention is to provide a real-scene tour simulation system and method of the same. Especially, the present invention relates to a simulation system and the method that could simulate real outdoor scenes interiorly, which makes a user feel like taking an interactive tour in the real world.

The present invention also provides a real-scene tour simulation system and method of the same. Particularly, it relates to a multi-user real-scene tour simulation system and method that could, based on the user's choice, simulate real outdoor scenes interiorly and provide multiple users or a single user an interactive indoor real-scene simulation tour.

The real-scene tour simulation method of the present invention uses a tour location display system to allocate a tour location and load in environment parameters such as the terrain, the atmospheric temperature, the sunshine intensity, the environment audio effect and etc. associated with the tour location. The user can select the single user mode or the multi-user mode. The user's video and audio information will then be transmitted to all other users traveling in the same group, and the real-scene tour simulation system of the present invention will simulate the real scene of a tour according to the environment parameters associated with the tour location as well as the user's video and audio information, and then, the result of the simulation will be presented to the user taking the tour. The user can take an indoor tour just like taking a tour in a real scene in the real world.

In one preferred embodiment, the real-scene tour simulation system of the present invention is connected to a server via a communication connection. The real-scene tour simulation system comprises a tour location display system used to select a tour location; an environment simulation system used to simulate the real environment and present it to the user; a control unit used to control the operation of the real-scene simulation system; an input device for providing the user a function to input the tour location; and an input/output port connected to the communication connection to input or output information from the environment simulation system. The environment simulation system further comprises an activity system for providing a platform to perform activities on; a display device used to display images to the user; an audio system used to create the environmental sound effect of the tour location; an air conditioning system used to create an airflow effect of the tour location; a controlled light source used to control the light of the tour location and a video and audio capturing device used to capture the user's video and audio information. The activity system inputs the user's moving activity into the control unit, and the control unit will incorporate the user's moving activity into the environment parameters associated with the tour location, generate the simulation result and present the result on the display device, the audio system, the air conditioning system and the controlled light source.

The server in the preferred embodiment of the present invention could determine the message outputted from the real-scene tour simulation system. If the message shows that a user is needed to add to a group and that group exists, the server will obtain an identification information of the group and add the user to the group, later, the identification information will be used to transmit the user's video and audio information to other users traveling in the same group. If the group does not exist, the server will build a new group and add the user to the new group, later, the identification information of the new group will be used to transmit the user's video and audio information to other users in the same group. When one user wants stop the tour, the server will delete the user from the group and the user's video and audio information will no longer be transmitted to other users in the same group.

The communication connection of the preferred embodiment of the present invention can be a LAN (Local Area Network), WAN (Wild Area Network), Internet or any other kinds of network with any possible communication protocol such as TCP/IP, IPX/SPX and NetBEUI (only for LAN). Moreover, the conventional Client/Server, Multi-Tiers and Peer-to-Peer can be the possible network structures adapted in the preferred embodiment of the present invention. Another embodiment of the present invention illustrates that the input/output port used in the present invention could be RS-232 or USB and that the database could be relational database such as MS SQL Server or Oracle or other Object-Oriented DBMS.

One of the preferred embodiments of the present invention shows that the user can perform any kind of activity, such as jogging, walking or lying down on the platform of the activity system of the present invention. The activity system will simulate the user activity scenario based on the activity parameter, then, the user can perform the activity interiorly just like he performs the activity outdoor in the real world. Moreover, the activity system of the present invention could be built up with a sporting exercise equipment such as treadmill and bike and the tour location display system could be constructed with a geographical information system or an expert system to provide the user an interactive tour.

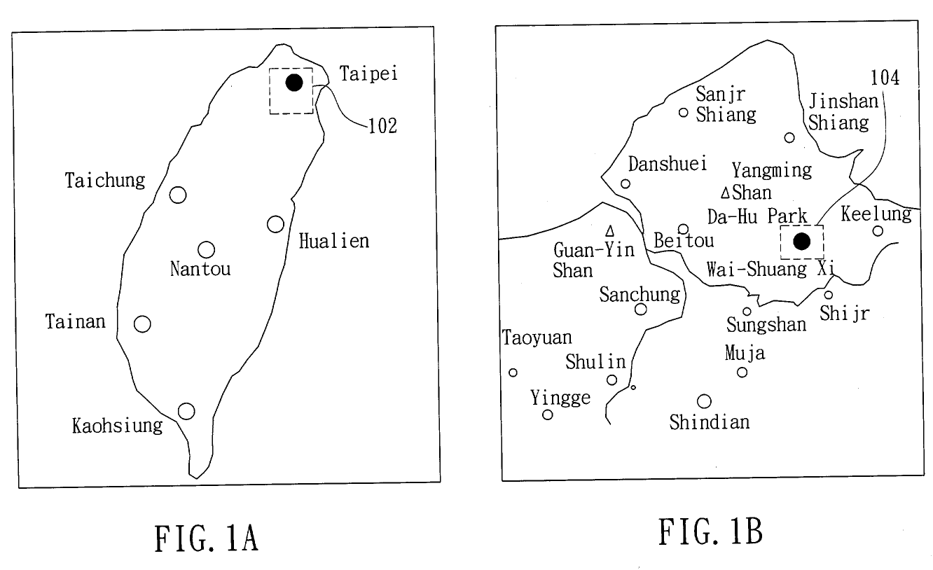

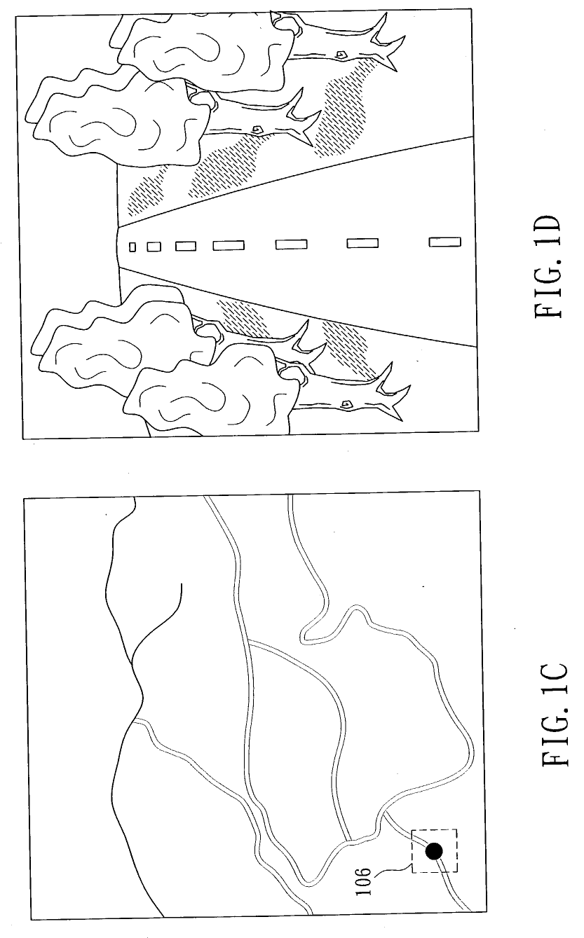

FIG. 1A to FIG. 1D show the diagrams illustrating an example of how a user selects a tour location via a geographical information system.

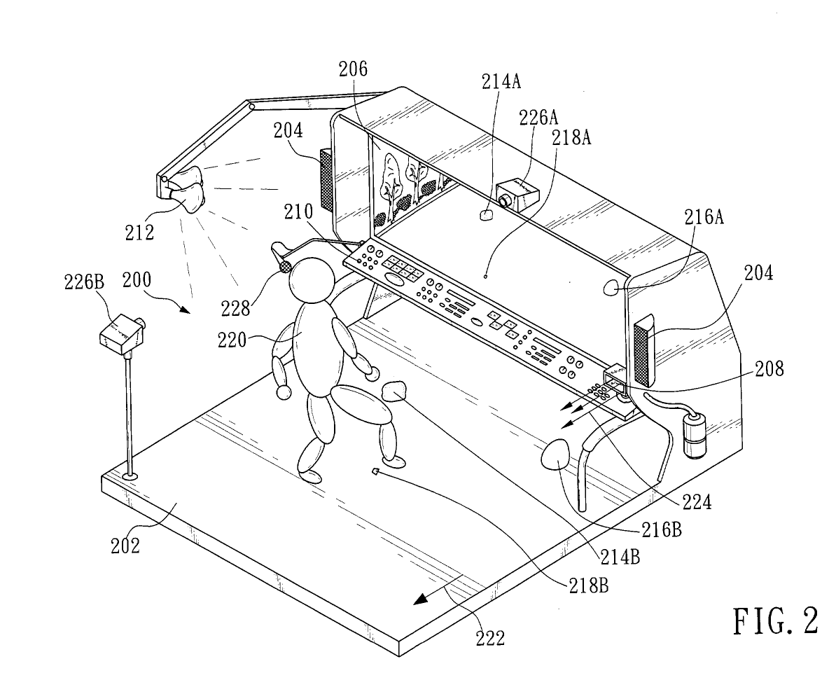

FIG. 2 shows a preferred embodiment of the present invention where a user takes tours on an activity platform.

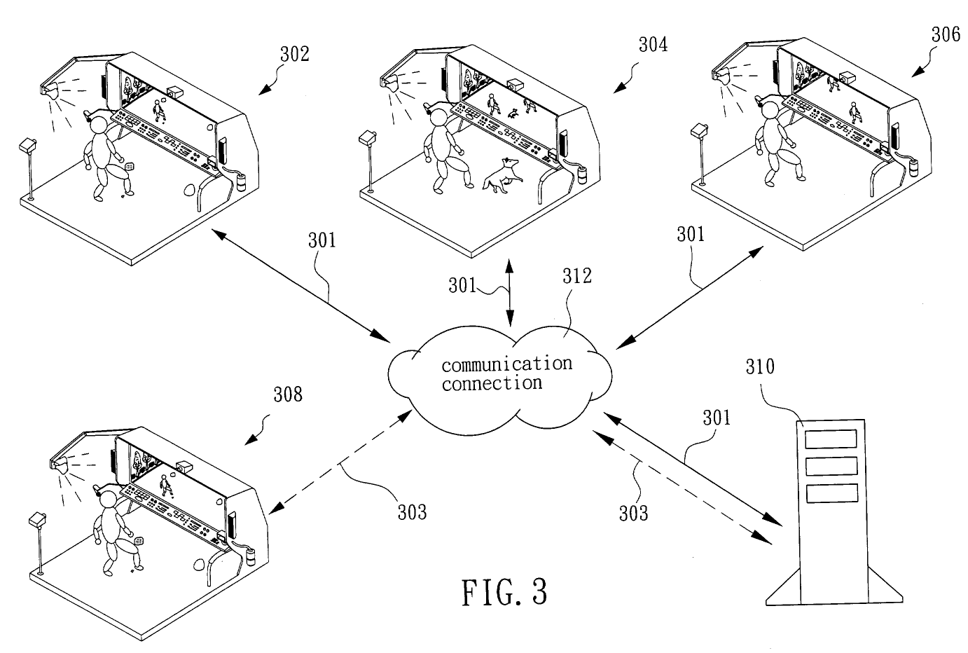

FIG. 3 shows another preferred embodiment of the present invention where multiple users take a same tour with the real-scene tour simulation systems of the present invention.

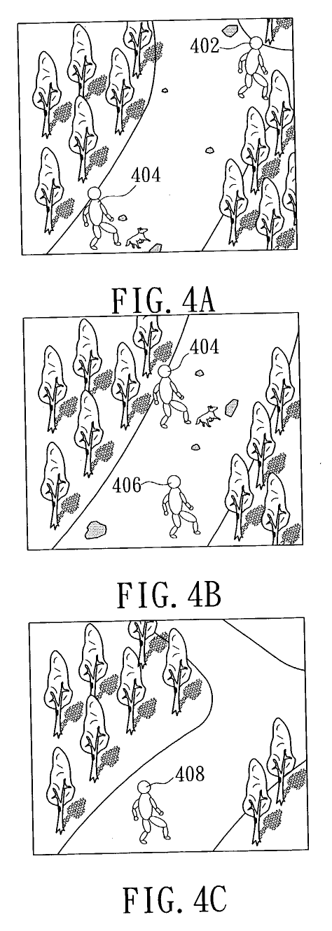

FIG. 4A to FIG. 4B illustrate the situation showing on a display screen when the users in the same group take a tour with the real-scene tour simulation system of the present invention.

FIG. 4C illustrate the situation showing on the display screen when a single user takes a tour with the real-scene tour simulation system of the present invention.

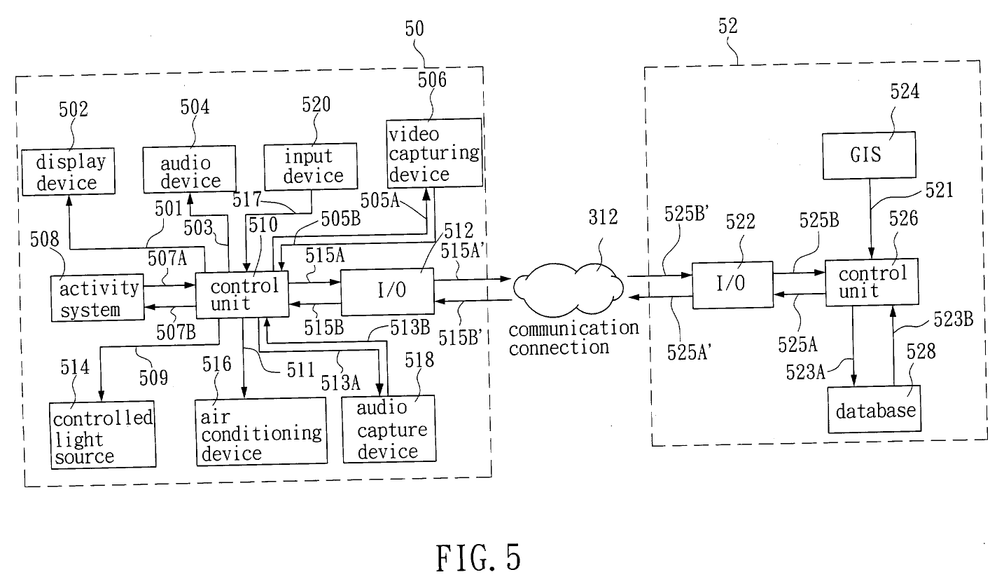

FIG. 5 shows a block diagram of the structure of the real-scene tour simulation system of the present invention.

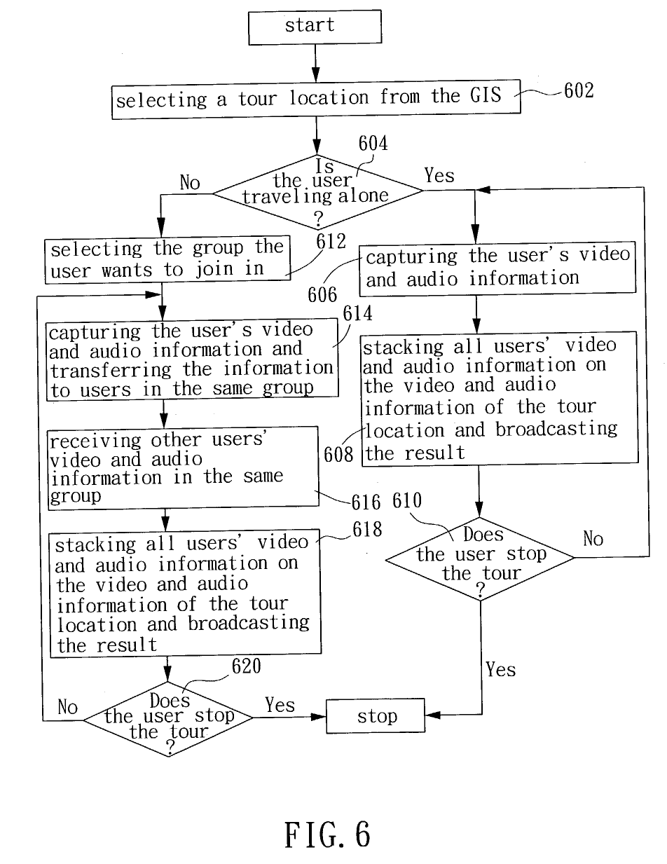

FIG. 6 shows a diagram of the operational flow chart of the real-scene tour simulation system of the present invention.

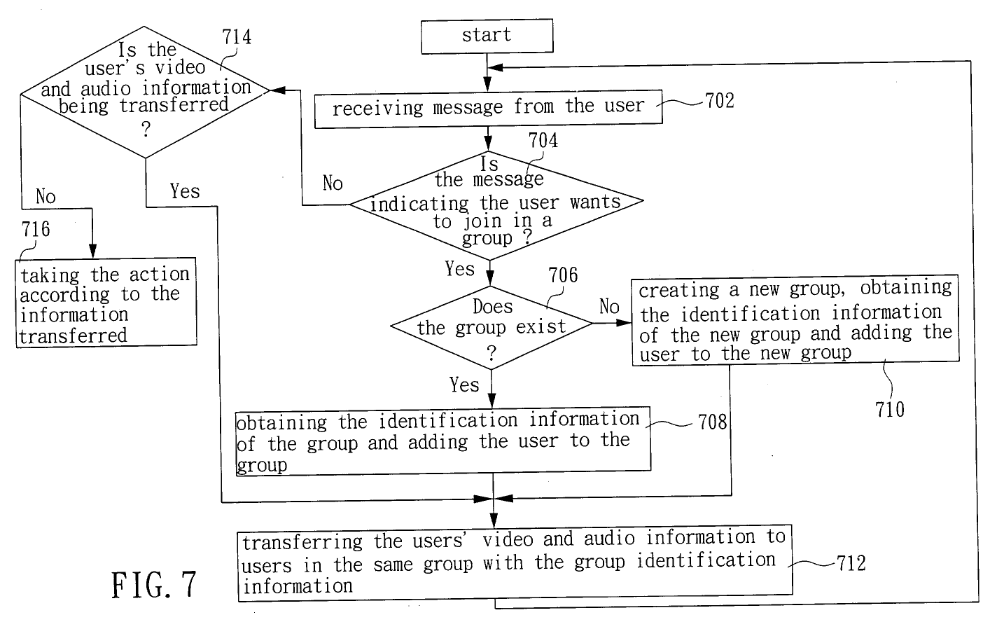

FIG. 7 shows a diagram of the operational flow chart of the server of the real-scene tour simulation system of the present invention.

### DETAILED DESCRIPTION OF THE PRESENT INVENTION

Please refer to FIG. 1A to FIG. 1D, FIG. 1A to FIG. 1D show the diagrams illustrating an example of how a user selects a tour location via a geographic information system (GIS). The tour locations shown in FIG. 1A to FIG. 1D include holiday resorts, historical interests and hot tourist spots in Taiwan. In fact, the preferred embodiments of the present invention cover any country as well as any place in the universe via the geographic information system. For example, the geographic information system can provide the world map (or can be the map of the Moon, the Solar System or the Universe) for selection, and a user can select any country on the world map for tour, the system of the present invention will simulate the sightseeing associated to the selection interiorly thus making the user feel like taking a real outdoor tour while having an indoor activity.

Firstly, the user can select a city on the map of Taiwan, as shown in FIG. 1A, by using a cursor 102, say selecting, Taipei as the city to visit. The geographic information system therefore displays the map of Taipei as shown in FIG. 1B to the user and the user uses a cursor 104 to select a tour location, and as shown, the tour location is Da-Hu Park. The geographic information system further displays the scene of Da-Hu Park to the user, as illustrated in FIG. 1C, and the user uses a cursor 106 to select the starting point at the chosen tour location to proceed the tour. Finally, the real-scene tour simulation system of the present invention displays the scene at the starting point of the tour via FIG. 1D and simulates the environment of the start pointing then presents to the user. One important thing is that the user almost can select any location for tour, however, in the reality, some geographical environments can never be realized, at least not with the current technologies. For example, if the user selects the “cloud” in the sky as the tour location, it will be an impossible one because of the limitation of the technology. In another case, unless the user selects a transportation tool (such as a boat) first, he/she will not be able to “walk” in the river. In one preferred embodiment, the system of the present invention will determine if the tour can be taken based on the location selected by user. If the tour cannot be taken in a reasonable way, the system will automatically select a possible tour location for user, or via Virtual Reality (VR) technology, to simulate the scene of the selected tour location and present to the user. For example, if the user selects a tour traveling in the river, the system will display a scene just like the user is taking the tour riding in a boat. Various possible modifications, omissions, and alterations could be conceived of by persons skilled in the art to the form and the content of any particular embodiment described above, without departing from the scope of the present invention.

FIG. 2 shows a diagram that the user takes a tour with the real-scene tour simulation system 200. As shown in the figure, the real-scene tour simulation system 200 of the present invention comprises an activity platform 202, a speaker 204, a display screen 206, an air conditioning device 208, a keyboard 210, a controlled light source 212, cameras 226A and 226B, a microphone 228, and the user 220 performing activities on the activity platform 202. When the user uses the real-scene tour simulation system for taking a tour, he/she can use the keyboard 210 to select a tour location, and the operational flow for selecting a tour location is shown in FIG. 1A to FIG. 1D. Once the tour location has been selected, the scene of that tour location will be displayed to the user 220 via the display screen 206, the condition of the temperature and the sunshine will be simulated by the air conditioning device 208 and the controlled light source 212 and presented to the user 220. A video information on the user in associate with the tour is captured by the cameras 226A and camera 226B and added to the scene of the tour in real time, and the result will be displayed on the display screen 206 and shown to the user 220. An audio information generated from the user during the tour (such as conversations between users) is collected by the microphone 228 and broadcasted to other users traveling in the same tour group. Certainly, the video and the audio information can both be collected by the cameras 226A or 226B instead of using the microphone 228, however, the modification will be various depending on the practical requirement. Moreover, the geographical environment condition of the tour is simulated by the activity platform 202. For example, when the user is walking up a slope, the activity platform 202 will calculate the related variables, such as the degree of inclination, and simulate the geographical environment condition based on the slope of the road, which makes the user need to apply more energy to walk on the road simulated on the activity platform 202. In another example, if the scene selected by the user has a big stone 214A, a small stone 218A and a pit 216A on the road, the system will generate the situation and present on the activity platform 202, thus making the user feel like walking on the road with all the stones and pits. To simulate that scenario, the real-scene tour simulation system 200 will send out an associated signal and the activity platform 202 will simulate accordingly. When the user 220 enters the simulated tour location, the activity platform 202 will present extruding objects 214B, 218B and a pit hole 216B corresponding to the stones 214A, 218A and the pit 216A. So, when the user 220 steps on the extruding objects 214B and 218B, it will make the user 220 feel like stepping on the stones 214A and 218A, in the same way, when the user 220 steps on the pit hole 216B, it makes the user feel like stepping on the pit 216A. In another example, when the user is moving faster (the moving direction of the activity platform 202 is represented by an arrow 222), the air conditioning device 208 will increase the speed of the wind blow (the wind direction of the air conditioning device 208 is represented by an arrow 224) to make the user to have the feeling of just like taking a real tour. In another matter of fact, when the user starts the tour activity (such as walking or jogging), the controlled light source 212 will change the brightness of light depending on the shadow of the trees or the mountains on both sides of the road. Besides, even the user is not on the activity platform 202, the real-scene tour simulation system 200 of the present invention can still simulate the real scene at the tour location and present it to the user. Certainly, for some tour spot like a beach in Hawaii, the user can lie down on the activity platform 202 and the system will simulate the scenario of the beach, the speaker 204 will create a sound effect just like an ocean wave tapping on the beach, the display screen 206 will show clouds in the blue sky, the air conditioning device 208 will create the warm breeze from the beach and the controlled light source will illustrate the sunshine on the Hawaiian beach. More importantly, the activity platform 202 in FIG. 2 can be any conventional sporting exercise equipment such as a treadmill or a bike. Some other video game systems such as the car racing game platform can also be built in the real-scene tour simulation system 200. Moreover, the quantity and the arrangement of the speaker 204, the air conditioning device 208, the cameras 226, the microphone 228 and the controlled light source 212 will not be limited as shown in the FIG. 2, any modification can be made by person skilled in the art based on the described embodiment without departing from the scope of the present invention.

FIG. 3 shows another preferred embodiment of the present invention where multiple users take the same tour with a plurality of the real-scene tour simulation systems of the present invention, wherein, a Client/Server structure is illustrated with the present invention and the communication connection such as wireless network, local area network, wide area network, internet or any other kind network is used to transfer information; and any communication protocol like TCP/IP, IPX/SPX, and even NetBEUI (only in LAN) can be used with the present invention. Any person skilled in the art would understand that the network structures like the Multiple-Tiers one, the Peer-to-Peer one could be implemented with the present invention. In FIG. 3, since the users of the real-scene tour simulation systems 302, 304 and 306 are in the same group, all the users are shown on every display screen of the real-scene tour simulation systems 302, 304 and 306. For example, if a situation exists that a user 402 of the real-scene tour simulation system 302 is moving at the fastest pace, a user 404 of the real-scene tour simulation system 304 is moving at a medium pace and a user 406 of the real-scene tour simulation system 306 is moving at the slowest pace, the users 404 and 406 of the real-scene tour simulation systems 304 and 306 respectively will see the scenes as illustrated in FIG. 4A and FIG. 4B. Furthermore, the real-scene tour simulation systems 302, 304 and 306 could transfer information (the audio and the video information) to and from each other via links 301 through the communication connection 312 to a server 310. Since the user 408 of the real-scene tour simulation system 308 is a single user taking a tour alone, the user only sees himself on the display screen of the real-scene tour simulation system 308 as illustrated in FIG. 4C. Also, the real-scene tour simulation system 308 could transfer information to and from the server 310 via route 303 shown in the dashed lines. Certainly, all the real-scene tour simulation systems in the embodiments could transfer information, such as the geographic information and the device driver, via the communication connection 312. More importantly, even the users 402, 404, 406 and 408 of the real-scene tour simulation systems take tours at the same location, the user 408 of the real-scene tour simulation system 308 will not see other users because he/she is not in the same tour group. Therefore, one tour location can be taken by many users at the same time, and a user only see other users traveling in the same tour group. Therefore, the present invention not only simulates the real outdoor sightseeing interiorly, but also provides a group segregation function to protect the individual privacy. Of course, the person skilled in the art could determine if invoke the segregation function depending on the requirement, and such modification is without departing from the scope of the present invention.

Please refer to FIG. 5 now, which shows a block diagram of the real-scene tour simulation system of the present invention. Wherein a real-scene tour simulation system 50 is connected to a server 52 via a communication connection 312. The real-scene tour simulation system comprises a display device 502 (including the display screen 206 of FIG. 2) used to display the scenes to the user; an audio device 504 (including the speaker 204 of FIG. 2) used to broadcast the audio signal of the environment at the tour location; a video capturing device 506 (including the camera 226A and the camera 226B of FIG. 2) used to capture the user's video information; an activity system 508 (including the activity platform 202 of FIG. 2) provided to the user for performing activities on; a control unit 510 used to control the operation of the real-scene tour simulation system; an input/output port 512 connected to the communication connection 312 to transfer information; a controlled light source 514 used to adjust the brightness of light according to the tour location; an air conditioning device 516 used to generate the wind at the tour location; an audio capturing device 518 (including the microphone 228 of FIG. 2) used to record the user's audio information when taking a tour; an input device 520 (it could be the keyboard 210 of FIG. 2) with which the user input the tour location. After the user selects the tour location with the input device 520, relevant instructions and parameters will be inputted (along with a route 517) to the control unit 510. Then, the control unit 510 transfers the control signals to the video capturing device 506 and the audio capturing device 518 via routes 505A and 513A. The video capturing device 506 and the audio capturing device 518 then captures and collects the video and the audio information of the user respectively and transfer the information back to the control unit 510 via routes 505B and 513B. The control unit 510 will process the video and audio information and transfer the processed signal to the display device 502, the audio device 504, the activity system 508, the air conditioning device 516 and the controlled light source 514 via routes 501, 503, 507B, 511 and 509 to simulate the real scene of the tour location. Meanwhile, the performance that the user performs on the activity system 508 will be transferred to the control unit 510 via the route 507A. After the user starts the tour, the activity system 508 will input the information indicating the user's movement in the tour to the control unit 510 via the route 507A, and the control unit 510 will obtain the environment parameters on the terrain, the atmospheric temperature, the sunshine intensity and the environment audio effect associated with the tour location according to the user's movement in the tour. The control unit 510 will further calculate, simulate the parameters and present the simulation result to the display device 502, the audio device 504, the controlled light source 514 and the air conditioning device 516. The method of detecting the user's movement and the description of the interactive actions between the user and the real-scene tour simulation system could be referenced to another invention “Interactive Real-Scene Tour Simulation System and Method of the Same” presented by the same inventor of the present invention. Moreover, when the real-scene tour simulation system 50 needs to communicate with the server 52 (such as transferring the user's video/audio information to other users traveling in the same group or updating the geographic information), the information will first be transferred to the input/output port 512 via route 515A and the information will be further transferred to the server 52 via the communication connection 312 along route 515A′. In a reverse case, when the server 52 needs to communicate with the real-scene tour simulation system 50, the information will be transferred to the communication connection 312 and then to the input/output port 512 via route 515B′, and the information will be further transferred to the control unit 510 via route 515B. Basically, the server 52 in the preferred embodiment only transfers the user's video and audio information to the relevant group but not performing the “stack” operation. But in some certain structures, such as a powerful server with a relatively weak client computer (like a thin client computer), the server will handle all of the operations and display the operation result (including the result of the stack operation) to the client computer.

The server 52 comprises another input/output port 522 used to connect to the communication connection 312 for information transfer, a geographic information system 524 with which the user could select the tour location, another control unit 526 used to control the operations of the server 52 and a database 528 used to store user group information. The information from the real-scene tour simulation system 50 could be inputted to the input/output port 522 via the communication connection 312 along route 525B′, and further along route 525B, and inputted to the control unit 526 for process. The partial operation of the control unit 526 is illustrated as follow. For example, if the information sent by the user is the control signal for updating the geographic information, the control unit 526 will input an updated information from the geographic information system 524 along route 521, and the information will be further transferred back to the real-scene tour simulation system 50 via the input/output port 522. In another case, if the information sent by the user is the control signal to add a user to a group, the control unit 526 will retrieve the group information (such as the identification information) from the database 528 and add the user to the group, and at the same time, update the group information. And this newly updated information will be sent to the database 528 along route 523A for storage and will be used as the group identification information when a user's video and audio information need to be sent to the group.

The display device 502 and the audio system 504 in the real-scene tour simulation system 50 could be built up with any kind of multimedia device or system, and the air conditioning device 516 and the controlled light source 514 can be any common system. For example, the display device 502 could be a cathode-ray-tube (CRT) display system, a liquid crystal display (LCD) system or a plasma display system. Large size display screen and activity platform could be used to create better simulation effect, and numerous screens installed at different angles will also generate excellent simulation scene. Besides, the audio device 504 could be a general twin-channel panning audio device, a hi-fi stereo system or a home theater 5.1 D audio system. The air conditioning device 516 and the controlled light source 514 could be any available device or system in the market. The control unit 510 can be built on any operation system (such as Linux) or with any Application Specific Integrated Circuit (ASIC) and embedded in the real-scene tour simulation system to read program code and control the operation. The program code (such as the one used to control the operation in FIG. 6) could be stored in the ASIC or a memory that can be read out by the ASIC (like ROM, EEPROM or Flash). Moreover, the geographic information system or the expert system in the embodiment of the present invention could be embedded directly in the ASIC and provide the information when the user selects the tour location or provide the real time information via the communication connection 312. The input device 520 could be any kind of keyboard such as the keyboard connected directly with the activity system 508 Oust like the control keyboard 210 illustrated in FIG. 2) or a separate keyboard, or can be a wireless transfer device (such as a remote controller). The input/output port 512 could be any type of I/O port such as RS232 or USB. The activity system 508 used in the present invention could be any activity system that is able to receive the simulation signal (such as the signal indicating a protruding object or a pit) from the control unit 510, without departing from the scope and the spirit of the present invention. The database 528 within the server 52 could be any type of database such as a relational database SQL, Oracle or an Object-Oriented DBMS. The control unit 526 within the server 52 could be built with a CPU or a Microprocessor. The program code (such as the one used to control the flow in FIG. 7) used to control the operation of the server could be stored in the hard disk in the server or in a memory (such as ROM, EEPROM or Flash) that can be read by the control unit 526. The input/output port 522 could be any type of I/O port such as RS232 or USB and the geographic information system (GIS) 524 could be replaced by an expert system.

Next, FIG. 6 and FIG. 7 will illustrate the operational flow of the real-scene tour simulation system 50 and the server 52 in the preferred embodiments of the present invention.

When a user employs the real-scene tour simulation system 50 to take a tour, he/she could select a tour location (step 602) on the geographic information system provided by the real-scene tour simulation system 50. The user can choose between the single mode (traveling alone) or multiple users mode (join in a group and traveling with the group), as what is illustrated in step 604. When the user decides to take the tour alone (the single mode), the real-scene tour simulation system 50 will capture and collect the user's video and audio information (step 606), stack the all the information onto the video and audio information of the tour location and present the result to the user (step 608). More importantly, the real-scene tour simulation system 50 will obtain the environment parameters of the terrain, the atmospheric temperature, the wind speed and the audio effect of the tour location and simulate the terrain, the atmospheric temperature, the sunshine intensity, the environment audio effect associated with the tour location according to the parameters, and then stack the user's video and audio information onto the simulation result and present the result to the user. Step 606 to step 608 will be repeated until the user stop the tour (step 610).

In another case, when the user decides to join a group to take a tour with another user or other users, the real-scene tour simulation system will select the group first (step 612) and then capture and collect the user's video and audio information and transfer the information to the other user(s) traveling in the same group (step 614). After the real-scene tour simulation system received all the video and audio information of all the users in the same group (step 616), it will stack all the users' video and audio information onto the video and audio information of the tour location and present the result to the users (step 618). More importantly, the real-scene tour simulation system 50 will obtain the environment parameters of the terrain, the atmospheric temperature, the wind speed and the audio effect of the tour location and simulate the terrain, the atmospheric temperature, the sunshine intensity, the environment audio effect associated with the tour location according to the parameters, and then stacked all the users' video and audio information onto the simulation result and present the result to all the users. Step 614 to step 618 will be repeated until the user stop the tour (step 620). In step 612, when the group that the user want to join does not exist or a new group need to be created, the real-scene tour simulation system 50 will send a relevant signal to the server 52, and the server 52 will create a new group in the database 528. In one of the preferred embodiments, the system will create identification information for each group, which can be used by the real-scene tour simulation system 50 or the server 52 as the identification tag, and the user's video and audio information will be sent to the user in the same group according to the identification tag.

FIG. 7 illustrates the diagram of the operational flow of the server 52. First, the server 52 receives the signal from the user end (e.g. the real-scene tour simulation system 50), in step 702. If the signal is a message on adding the user to a group (step 704) and the group exists (step 706), the server 52 will obtain the identification information of the group and add the user into the group (step 708). Later, the identification information of the group will be used when sending the user's video and audio information to other users in the same group (step 712). If the group does not exist, the server 52 will create a new group and add the user into the new group (step 710), then the identification information of the group will be used to send the user's video and audio information to other users in the same group (step 712). Certainly, if the control signal from the user is not to join any group and the user's video/audio information hasn't been transferred, the operation will perform according to the control signal (step 716). For example, when the user wants to stop the tour, the server 52 will delete the user from the tour group (the action needs to operate with database 528), therefore, the user's video and audio information will no longer be sent to other users in the same tour group. Besides, the identification information for each group should be different, otherwise, the system will not operate properly.

As a conclusion, the real-scene tour simulation system disclosed in the present invention will provide the user an indoor real-scene simulation tour just like taking a real outdoor sightseeing tour. The user could choose between the single mode for taking the tour alone or the multiple users mode to join a tour group. In the preferred embodiment of the present invention, the real-scene tour simulation system of the present invention will simulate the real scene of a tour based on the environment parameters of the terrain, the atmospheric temperature, the sunshine intensity, the environment audio effect associated with the tour location as well as the user's video and audio information, and then, the result of the simulation will be presented to the user. The user can take an indoor tour just like taking a tour in the real scene of real world.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the spirit of the present invention.

What is claimed is:

1. A real-scene tour simulation system that simulates real scenes interiorly to make a user feel like taking a real outdoor tour while performing an indoor activity, said real-scene tour simulation system comprises:
a tour location display system for providing tour locations for said user to select from, wherein said user can select a tour location from said tour location display system to proceed a tour;
an input device with which said user inputs said tour location for selection;
an environment simulation system for generating an environment-like simulation effect and presenting said environment-like simulation effect to said user, as well as for obtaining said user's video and audio information;
an activity system with which said user can perform activities on; and
a control unit responding to environment parameters of said tour location being selected and said user's video and audio information to generate a simulation result which simulates said user taking a real tour at said tour location, and to output said simulation result to said environment simulation system and said activity system and present to said user, wherein said user's video and audio information is stacked onto said simulation result generated by said environment parameters of said tour location.

2. The real-scene tour simulation system according to claim 1, wherein said tour location display system is selected from the group consisting of geographic information system (GIS) and expert system.

3. The real-scene tour simulation system according to claim 1, wherein said simulation result includes at least one of the following simulation results associated with said tour location: terrain; atmospheric temperature; sunshine intensity; and environmental sound effect.

4. The real-scene tour simulation system according to claim 1, wherein said environment simulation system comprises at least one of the followings: a display device; an audio device; an air conditioning device; and a light source, for presenting said simulation result of said tour location to said user.

5. The real-scene tour simulation system according to claim 4, wherein said display device is selected from the group consisting of cathode ray tube (CRT) display system, liquid crystal display (LCD) system and plasma display system.

6. The real-scene tour simulation system according to claim 4, wherein said audio device is selected from the group consisting of twin-channel panning sound system, hi-fi stereo system and home theater 5.1D sound system.

7. The real-scene tour simulation system according to claim 4, wherein said environment simulation system further comprises a video and audio capturing system for obtaining said user's video and audio information.

8. The real-scene tour simulation system according to claim 7, wherein said video and audio capturing system comprises a camera.

9. The real-scene tour simulation system according to claim 7, wherein said video and audio capturing system comprises a microphone.

10. The real-scene tour simulation system according to claim 1, wherein said activity system responding to said simulation result of said tour location, and thus presenting a terrain simulation result of said tour location to said user.

11. The real-scene tour simulation system according to claim 1, wherein said activity system comprises at least one of the followings: an exercise equipment system and a video game system.

12. The real-scene tour simulation system according to claim 1, wherein said user's video and audio information is presented on other environment simulation systems for other users traveling in a same group with said user.

13. The real-scene tour simulation system according to claim 12, wherein said user uses said input device to select said group to join in.

14. The real-scene tour simulation system according to claim 13, wherein when said user is not in any group, said user's environment simulation system only presents said user's video and audio information having stacked onto said simulation result generated by said environment parameters of said tour location.

15. The real-scene tour simulation system according to claim 12, wherein said user's video and audio information is transferred to said other environment simulation systems of said other users traveling in said group via a communication connection.

16. The real-scene tour simulation system according to claim 12, wherein said user's video and audio information is transferred to said other users traveling in said group via a communication connection, and is presented on said other environment simulation systems for said other users traveling in said group.

17. The real-scene tour simulation system according to claim 16, wherein said communication connection is connected with a server to transfer said user's video and audio information to said other environment simulation systems for said other users traveling in said group.

18. The real-scene tour simulation system according to claim 17, wherein said server comprises a database for storing group information for all users.

19. The real-scene tour simulation system according to claim 18, wherein said group information includes group identification information used to identify which group said user belongs to, and each of said group identification information is different.

20. The real-scene tour simulation system according to claim 17, wherein said server comprises information for updating to or downloading from said tour location display system.

21. A real-scene tour simulation system that simulates real scenes interiorly to make a user feel like taking a real outdoor tour while performing an indoor activity, wherein a plurality of said real-scene tour simulation systems are connected by a communication connection, which enable the users of said plurality of real-scene tour simulation systems to take a tour together, said real-scene tour simulation system comprising:
a tour location display system for providing tour locations for said user to select from, wherein said user can select a tour location from said tour location display system to proceed said tour;
an input device with which said user inputs said tour location of selection;
an environment simulation system for generating an environment-like simulation effect and presenting said environment-like simulation effect to said user, as well as for obtaining said user's video and audio information;
an activity system with which said user can perform activities on;
a control unit responding to environment parameters of said tour location being selected and said user's video and audio information to generate a simulation result which simulates said user taking a real tour at said tour location, and to output said simulation result to said environment simulation system and said activity system and present to said user, wherein said user's video and audio information is stacked onto said simulation result generated by said environment parameters of said tour location; and
an input/output port for receiving other users' video and audio information from said communication connection and for sending out said user's video and audio information to said communication connection.

22. The real-scene tour simulation system according to claim 21, wherein said tour location display system is selected from the group consisting of geographic information system (GIS) and expert system.

23. The real-scene tour simulation system according to claim 21, wherein said simulation result includes at least one of the following simulation results associated with said tour location: terrain; atmospheric temperature; sunshine intensity; and environmental sound effect.

24. The real-scene tour simulation system according to claim 21, wherein said environment simulation system comprises at least one of the followings: a display device; an audio device; an air conditioning device; and a light source, for presenting said simulation result of said tour location to said user.

25. The real-scene tour simulation system according to claim 24, wherein said display device is selected from the group consisting of cathode ray tube (CRT) display system, liquid crystal display (LCD) system and plasma display system.

26. The real-scene tour simulation system according to claim 24, wherein said audio device is selected from the group consisting of twin-channel panning sound system, hi-fi stereo system and home theater 5.1D sound system.

27. The real-scene tour simulation system according to claim 24, wherein said environment simulation system further comprises a video and audio capturing system for obtaining said user's video and audio information.

28. The real-scene tour simulation system according to claim 27, wherein said video and audio capturing system comprises a camera.

29. The real-scene tour simulation system according to claim 27, wherein said video and audio capturing system comprises a microphone.

30. The real-scene tour simulation system according to claim 21, wherein said activity system responding to said simulation result of said tour location, and thus presenting a terrain simulation result of said tour location to said user.

31. The real-scene tour simulation system according to claim 21, wherein said activity system comprises at least one of the followings: an exercise equipment system and a video game system.

32. The real-scene tour simulation system according to claim 21, wherein said user's video and audio information is presented on other environment simulation systems for other users traveling in a group.

33. The real-scene tour simulation system according to claim 32, wherein said user uses said input device to select said group to join in.

34. The real-scene tour simulation system according to claim 33, wherein when said user is not in any group, said user's environment simulation system only presents said user's video and audio information having stacked onto said simulation result generated by said environment parameters of said tour location.

35. The real-scene tour simulation system according to claim 32, wherein said user's video and audio information is transferred to said other users traveling in said group via a communication connection, and is presented on said other environment simulation systems for said other users traveling in said group.

36. The real-scene tour simulation system according to claim 35, wherein said communication connection is connected with a server to transfer said user's video and audio information to said other environment simulation systems for said other users traveling in said group.

37. The real-scene tour simulation system according to claim 36, wherein said server comprises a database for storing group information for all users.

38. The real-scene tour simulation system according to claim 37, wherein said group information includes a group identification information used to identify which group said user belongs to, and each of said group identification information is different.

39. The real-scene tour simulation system according to claim 36, wherein said server comprises information for updating to or downloading from said tour location display system.

40. The real-scene tour simulation system according to claim 35, wherein said communication connection is selected from the group consisting of LAN, WAN, Internet and Peer-To-Peer protocol.

41. A real-scene tour simulation method that simulates real scenes interiorly to make a user feel like taking a real outdoors tour, which comprising the following steps:
selecting a tour location on a tour location display system;
obtaining environment parameters of said tour location;
obtaining activity information from said user;
stacking said activity information onto an environment simulation result simulated based on said environment parameters to generate a real tour simulation result simulating said user taking said real outdoor tour at said tour location;
presenting said real tour simulation result to said user.

42. The real-scene tour simulation method according to claim 41, wherein said tour location display system is selected from the group consisting of geographic information system (GIS) and expert system.

43. The real-scene tour simulation method according to claim 41, wherein said real tour simulation result is presented to said user via an environment simulation system.

44. The real-scene tour simulation method according to claim 43, wherein said environment simulation system comprises at least one of the followings: a display device; an audio device; an air conditioning device; and a light source.

45. The real-scene tour simulation method according to claim 44, wherein said display device is selected from the group consisting of cathode ray tube (CRT) display system, liquid crystal display (LCD) system and plasma display system.

46. The real-scene tour simulation method according to claim 44, wherein said audio device is selected from the group consisting of twin-channel panning sound system, hi-fi stereo system and home theater 5.1D sound system.

47. The real-scene tour simulation method according to claim 41, further comprises an activity system for responding to the real tour simulation result of said tour location, and thus presenting a terrain simulation result of said tour location to said user.

48. The real-scene tour simulation method according to claim 47, wherein said activity system comprises at least one of the followings: an exercise equipment system and a video game system.

49. The real-scene tour simulation method according to claim 41, wherein said activity information includes said user's video and audio information.

50. The real-scene tour simulation method according to claim 41, wherein said environment simulation result includes at least one of the following simulation results associated with said tour location: terrain; atmospheric temperature; sunshine intensity; and environmental sound effect.

51. The real-scene tour simulation method according to claim 41 further comprises a step of obtaining an information of a group said user joined in before the step of obtaining said activity information.

52. The real-scene tour simulation method according to claim 51, wherein said activity information is presented to other users on other environment simulation systems within said group.

53. The real-scene tour simulation method according to claim 52, wherein when said user is not in any group, said environment simulation system of said user only presents said activity information having stacked onto said environment simulation result generated by said environment parameters of said tour location.

54. The real-scene tour simulation method according to claim 52, wherein said activity information is transferred via a communication connection.

55. The real-scene tour simulation method according to claim 54, wherein said communication connection is connected with a server to transfer said activity information to said other environment simulation systems for said other users traveling in said group.

56. The real-scene tour simulation method according to claim 55 further comprises a step of, after said activity information being transferred to said other users traveling in said group, presenting said activity information via said other environment simulation systems of said other users traveling in said group.

57. The real-scene tour simulation method according to claim 55, wherein said server comprises a database for storing group information for all users.

58. The real-scene tour simulation method according to claim 57, wherein said group information includes a group identification information used to identify which group said user belongs to, and each of said group identification information is different.

59. The real-scene tour simulation method according to claim 55, wherein said server comprises information for updating to or downloading from said tour location display system.

60. The real-scene tour simulation method according to claim 54, wherein said communication connection is selected from the group consisting of LAN, WAN, Internet and Peer-To-Peer protocol.

61. A real-scene tour simulation method that simulates real scenes interiorly to make a user feel like taking a real outdoor tour while performing an indoor activity, wherein a plurality of real-scene tour simulation systems are connected by a communication connection which enable the users of said plurality of real-scene tour simulation systems to take a tour together, said real-scene tour simulation method comprising the following steps:
selecting a tour location on a tour location display system;
obtaining environment parameters of said tour location;
obtaining an information of a group where said user joined in;
capturing said user's video and audio information;
transferring said user's video and audio information to other users traveling in said group via said communication connection;
stacking said user's video and audio information and other users' video and audio information in said group onto an environment simulation result simulated based on said environment parameters to generate a real tour simulation result simulating said user taking a real tour at said tour location; and
presenting said real tour simulation result to said user.

62. The real-scene tour simulation method according to claim 61, wherein said tour location display system is selected from the group consisting of geographic information system (GIS) and expert system.

63. The real-scene tour simulation method according to claim 61, wherein said real tour simulation result is presented to said user via an environment simulation system.

64. The real-scene tour simulation method according to claim 63, wherein said environment simulation system comprises at least one of the followings: a display device; an audio device; an air conditioning device; and a light source.

65. The real-scene tour simulation method according to claim 64, wherein said display device is selected from the group consisting of cathode ray tube (CRT) display system, liquid crystal display (LCD) system and plasma display system.

66. The real-scene tour simulation method according to claim 64, wherein said audio device is selected from the group consisting of twin-channel panning sound system, hi-fi stereo system and home theater 5.1D sound system.

67. The real-scene tour simulation method according to claim 61, further comprises an activity system for responding to said real tour simulation result of said tour location, and thus presenting a terrain simulation result of said tour location to said user.

68. The real-scene tour simulation method according to claim 67, wherein said activity system comprises at least one of the followings: an exercise equipment system and a video game system.

69. The real-scene tour simulation method according to claim 61, wherein said environment simulation result includes at least one of the following simulation results associated with said tour location: terrain; atmospheric temperature; sunshine intensity; and environmental sound effect.

70. The real-scene tour simulation method according to claim 61, wherein when said user is not in any group, said user's environment simulation system only presents said user's video and audio information having stacked onto said environment simulation result generated by said environment parameters of said tour location.

71. The real-scene tour simulation method according to claim 61, wherein said communication connection is connected with a server to transfer said user's video and audio information to other environment simulation systems for other users traveling in said group.

72. The real-scene tour simulation method according to claim 71, wherein said server comprises a database for storing group information for all users.

73. The real-scene tour simulation method according to claim 72, wherein said group information includes a group identification information used to identify which group said user belongs to, and each of said group identification information is different.

74. The real-scene tour simulation method according to claim 71, wherein said server comprises information for updating to or downloading from said tour location display system.

75. The real-scene tour simulation method according to claim 61, wherein said communication connection is selected from the group consisting of LAN, the WAN, the Internet and the Peer-To-Peer.
